(19) United States
(12) Patent Application Publication
(10) Pub. No.: US 2013/0151398 A1
(43) Pub. Date: Jun. 13, 2013

(54) PORTFOLIO RISK MANAGER

(71) Applicants: Devi Mateti, Plainfield, NJ (US); Keith Doyle, Dublin (IE); Curt Woodson Harris, Half Moon Bay, CA (US); Richard C. Johnsen, Chatham, NJ (US); Jeffrey Lewis Kaufman, Menlo Park, CA (US); Claire McCann, Westmeath (IE); Cynthia Marie Peterson, Land O Lakes, FL (US); Robert Porreca, Hillsborough, NJ (US); Sachin Rajpal, Franklin Park, NJ (US); Joao Reginatto, Dublin (IE)

(72) Inventors: Devi Mateti, Plainfield, NJ (US); Keith Doyle, Dublin (IE); Curt Woodson Harris, Half Moon Bay, CA (US); Richard C. Johnsen, Chatham, NJ (US); Jeffrey Lewis Kaufman, Menlo Park, CA (US); Claire McCann, Westmeath (IE); Cynthia Marie Peterson, Land O Lakes, FL (US); Robert Porreca, Hillsborough, NJ (US); Sachin Rajpal, Franklin Park, NJ (US); Joao Reginatto, Dublin (IE)

(73) Assignee: Dun & Bradstreet Business Information Solutions, Ltd., Dublin (IE)

(21) Appl. No.: 13/708,649

(22) Filed: Dec. 7, 2012

Related U.S. Application Data
(60) Provisional application No. 61/568,729, filed on Dec. 9, 2011.

(51) Int. Cl. G06Q 40/02

(52) U.S. Cl. CPC G06Q 40/025
USPC 705/38

(57) ABSTRACT

There is provided a method for portfolio risk management. The method includes (a) updating a transaction database with data relating to an operation of an entity, (b) synchronizing a reporting database to the transaction database, where the synchronizing comprises copying the data from the transaction database to the reporting database, (c) receiving a request to prepare a report, (d) obtaining the data from the reporting database, (e) preparing the report from the data obtained from the reporting database, and (f) outputting the report to a user interface. There is also provided a system that performs a method, and a storage device that includes instructions that control a processor to perform the method.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The present disclosure relates to a portfolio risk manager that provides a credit department with easy to access, one-click insight into credit related risk and opportunity inherent in a portfolio of customer accounts. The portfolio risk manager is an interactive reporting module consisting of user screens, services, business logic and data, delivered to users through an application platform.

2. Description of the Related Art

The approaches described in this section are approaches that could be pursued, but not necessarily approaches that have been previously conceived or pursued. Therefore, unless otherwise indicated, the approaches described in this section may not be prior art to the claims in this application and are not admitted to be prior art by inclusion in this section.

In an active database system, a database may be frequently, or almost continuously, updated. Moreover, the database may be updated by multiple users, or from multiple sources, and such updates may be nearly concurrent with one another.

Ordinarily, data that is placed into a database will thereafter be accessed, for example, to prepare a report. Thus, the access of the database for the preparation of reports places a further processing burden on the database system.

Additionally, when data is presented in a report, a user of such a report would typically prefer for the data to be the most up-to-date available. This is particularly important to users in the finance credit industry.

### SUMMARY OF THE INVENTION

There is a need for a database system that can accommodate frequent updates from multiple users, and also provide access to data for the preparation of reports. There is also a need for such reports to include data that is the most up-to-date available. The need for up-to-date data is particularly important in the finance credit industry.

An object of the present invention is to provide a system to rollup account information to a parent Data Universal Numbering System (DUNS) Number level when presenting report details. Another object of the present invention is to provide users with a corporate family credit exposure perspective.

Accordingly, there is provided a method for portfolio risk management. The method includes (a) updating a transaction database with data relating to an operation of an entity, (b) synchronizing a reporting database to the transaction database, where the synchronizing comprises copying the data from the transaction database to the reporting database, (c) receiving a request to prepare a report, (d) obtaining the data from the reporting database, (e) preparing the report from the data obtained from the reporting database, and (f) outputting the report to a user interface. There is also provided a system that performs a method, and a storage device that includes instructions that control a processor to perform the method.

A technical benefit of the utilization of the reporting database, rather than the transaction database, for the preparation of reports, relieves the transaction database of processing burdens associated with the preparation of the reports. Additionally, because of the synchronization of the transaction database and the reporting database, the data in the reporting database is very current, and the reports prepared therefrom will also contain very current data.

### BRIEF DESCRIPTION OF THE DRAWINGS

FIG. 1 is a functional block diagram of an application platform that includes a database and a portfolio risk manager.

FIG. 2 is a screen shot of a sample table provided by the portfolio risk manager of FIG. 1.

FIG. 3 is a screen shot of a sample bar chart provided by the portfolio risk manager of FIG. 1.

FIG. 4 is a screen shot of a sample pie chart provided by the portfolio risk manager of FIG. 1.

FIG. 5 is a screen shot of a sample drill-down provided by the portfolio risk manager of FIG. 1.

FIG. 6 is a block diagram of a system for implementation of the application platform, and more particularly the portfolio risk manager, of FIG. 1.

FIG. 7 is a functional block diagram of a process that synchronizes two databases.

FIG. 8 is a functional block diagram of a database synchronization process.

FIG. 9 is a functional block diagram of a process for generating a report from data in a reporting database that has been synchronized with a transaction database.

### DESCRIPTION OF THE INVENTION

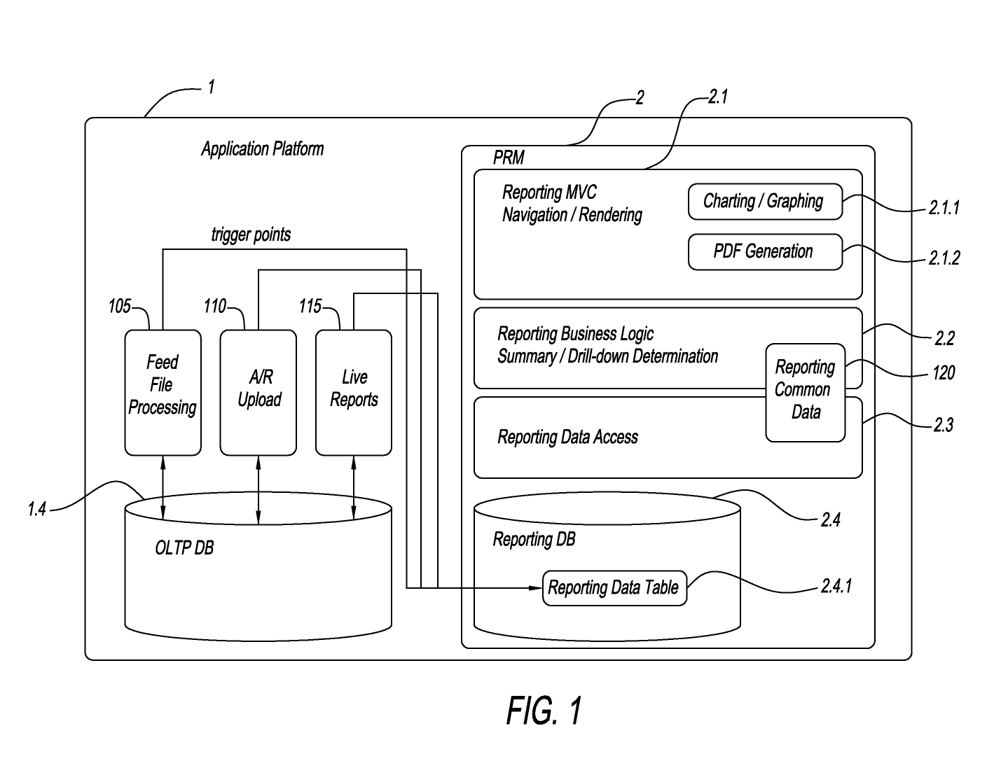

FIG. 1 is a functional block diagram of an application platform 1 that includes an online transaction processing (OLTP) database, i.e., a database 1.4, and a portfolio risk manager (PRM) 2.

PRM 2 provides a credit department with easy-to-access, one-click insight into credit related risk and opportunity inherent in a portfolio of customer accounts. PRM 2 is an interactive reporting module consisting of user screens, services, business logic and data, delivered to users through application platform 1. PRM 2 is a web-based, i.e., Internet-based, application through which users can access a variety of pre-determined reports.

PRM 2 has an architecture consisting of four tiers, namely, a Reporting Model-View-Controller (MVC) tier 2.1, a Reporting Business Logic tier 2.2, a Reporting Data Access tier 2.3, and a Reporting database 2.4.

Via Reporting MVC tier 2.1, at the top, a user interacts with dynamic web pages that are part of a framework of Reporting MVC tier 2.1. Reporting MVC tier 2.1 controls inputs from users, navigation through various report functionalities, rendering of reports and charts via a charting/graphing function 2.1.1, and delivery of data via printing, email and portable document format (PDF) via a PDF generation function 2.1.2.

Reporting Business Logic tier 2.2 is underneath Reporting MVC tier 2.1, and is responsible for data analysis, categorization, calculation of summary table and drill-down information, and customizations. Reporting Business Logic tier 2.2 is responsible for producing main insights that will be delivered to users. Reporting Business Logic tier 2.2 leverages Reporting Data Access tier 2.3.

Reporting Data Access tier 2.3 abstracts a complexity of a data model, making it easier for the calculations and insights to be determined.

Reporting common data 120 is a representation of data that is received from Reporting database 2.4. Reporting common data 120 is shared by Reporting Business Logic tier 2.2 and Reporting Data Access tier 2.3.

Reporting database 2.4 is a relational database system consisting of a main reporting relational table, i.e., Reporting Data table 2.4.1, and several satellite relational tables (not shown in FIG. 1). Reporting Data table 2.4.1 is a denormalized table, which employs a technique to optimize the performance of read operations in a relational data source. The optimization is achieved by grouping related data elements in a single relational table, even if that means somewhat storing redundant information. Such technique allows for very simple database queries to be used (without the use of expensive join operations, for example) hence optimizing the performance of complex reporting calculations that would otherwise be potentially resource-intensive and time-consuming.

PRM 2 prepares reports for users from data in Reporting Data table 2.4.1. Accordingly, PRM 2 includes a synchronization process that synchronizes Reporting Data table 2.4.1 with database 1.4. More specifically, the synchronization process updates Reporting Data table 2.4.1 soon after an update is made to database 1.4. Database 1.4. may be updated as a result of many processes, several of which are represented in FIG. 1, namely feed file processing 105, an account receivable (A/R) upload 110, and a live report 115. Each of processes 105, 110 and 115 serves as a trigger point that causes an invocation of the synchronization process.

PRM 2 integrates customer portfolio data, in the form of A/R files, with risk data. Reporting database 2.4 is fed from various trigger-points in database 1.4 that are associated to the customer portfolio data and risk data. In practice, users can upload A/R files into application platform 1, and once they do it, that data is fed into Reporting database 2.4 in near real-time. That portfolio data is then enriched with risk data that can include multiple credit scores and linkage information, i.e., data that provides a hierarchical relationship between business entities in a family tree. Once all the customer portfolio and risk data is available in Reporting database 2.4, users can then pull reports by way of a user interface via the web.

Users interacting with PRM 2's web-based user interface pull a number of different reports. All PRM 2's reports are generated online, meaning that the insights are calculated on-the-fly based on the data available at the moment and based on user inputs such as filters, customizations and requests for different perspectives. That allows users great flexibility in the sense that they can provide different inputs and look at the data from different perspectives, and still obtain answers from PRM 2.

From a technology perspective, PRM 2 has been developed as a Java web-based application that makes use of various web technologies to build an interactive user experience. PRM 2 has been developed as a framework so that the addition of new reports is straightforward.

PRM 2 has a couple of noteworthy capabilities. A first capability of PRM 2 is an ability to rollup account information to a parent Data Universal Numbering System (DUNS) Number level when presenting report details. DUNS is a system developed and regulated by Dun & Bradstreet (D&B) that assigns a unique numeric identifier, referred to as a “DUNS number” to a single business entity. The DUNS number is a nine-digit number, issued by D&B, assigned to each business location in the D&B database, having a unique, separate, and distinct operation for the purpose of identifying the business location. A second capability of PRM 2 is to provide users with a corporate family credit exposure perspective.

With regard to the ability to rollup account information to a parent DUNS number level when presenting report details, as mentioned above, users upload A/R files into application platform 1. Once that is done, application platform 1 will attempt to match every account in the uploaded file with a company identified by a DUNS number. After the accounts are matched, the information is fed into Reporting database 2.4. Users then run reports in PRM 2, and in each report the users can drill-down on specific categories consolidated in a summary table view. In doing that, PRM 2 will present users with detailed information on the accounts pertaining to the selected category. Since Reporting database 2.4 has a corresponding unique DUNS number for each account, Reporting Business Logic tier 2.2 consolidates information on a DUNS number level, rolling up outstanding amounts and other values and presenting all accounts that match a given DUNS number nested together. This capability is enabled by application platform 1's company database, i.e., database 1.4 (identified by DUNS numbers) and by Reporting Business Logic tier 2.2's ability to rollup amounts to the parent level when accounts have matching DUNS numbers. It allows users to visualize consolidated A/R data which otherwise would be scattered across multiple accounts in their portfolios. Thus, PRM 2 presents a list of accounts in a drill-down feature in which DUNS number rollup and customer account information are combined to provide a user with a perspective for the list of customers the user has loaded into PRM 2.

With regard to the ability to provide users with a corporate family credit exposure perspective, PRM 2 utilizes a corporate family linkage database, i.e., database 1.4, that associates companies pertaining to the same family (headquarters, subsidiaries) around the world. Companies that belong to the same family are associated with a unique Global Ultimate DUNS number. When users upload A/R files into application platform 1, each account is also matched against a Global Ultimate DUNS number before being fed into Reporting database 2.4. When users then run a corporate family linkage report in PRM 2 they can visualize credit exposure data for all corporate families in their portfolio. In other words, PRM 2 will rollup exposure amounts to the Global Ultimate DUNS number level, allowing users to visualize hidden credit risk information in their portfolios. This capability is enabled by application platform 1's corporate family linkage database, i.e., database 1.4, (identified by Global Ultimate DUNS numbers) and by Reporting Business Logic tier 2.2's ability to rollup amounts to the corporate family level when accounts have matching Global Ultimate DUNS numbers. Thus, a corporate linkage report provides a user with a view into corporate exposure rollup and accounts. Connections are provided between the highest level family tree (and largest exposure dollars) entities and how they connect to accounts the user has loaded into PRM 2.

PRM 2 provides a user the following:
(a) Perform portfolio analysis faster with one-click actionable portfolio reports and real-time insight;
(b) More effectively and proactively manage risk by setting credit and collections policies based on current risk, trends in a portfolio of accounts and benchmarks against national average;
(c) Drill-down into areas of risk and opportunity helps drive sales and reduce Bad and Debt and Days Sales Outstanding;
(d) Improve Internal Communication and Cooperation with management reports that will enable a user to share critical insights and risk trends; and
(e) Partner with sales and marketing to drive profitable growth by identifying low risk, strong up-sell candidates within a portfolio of accounts.

Overarching Features and Functionalities that help customers solve their Portfolio Management issues:
(a) Access a variety of Predetermined Portfolio Analysis reports;
(b) View Insight in multiple formats: Tabular, Graphical and Drill-down capabilities available across the product;
(c) Customize how to view reports: Select scores used to generate reports, assign risk labels to score bands, designate probability of default values (BDR) for select types of entities;
(d) Apply Filters to create reports that are impactful at the user-level;
(e) Drill-Down capabilities and lists provide the low-level detail required to take action at the account level;
(f) Share the insights PRM has provided through print, email and PDF; and
(g) Leverage an executive report aggregator to build a credit report that communicates.

Table 1 shows a correlation between customer issues and PRM 2 reports.

TABLE 1

| Customer Issues | Portfolio Risk Manager Report |
|---|---|
| Identify best and worst | Failure and Delinquency report provides |
| credit customers | account level insight into payment |
| | performance and business credit/failure |
| | related risk. |
| | Industry report provides insight into best |
| | and worst performing industries. |
| | Geography report, Size of Business and |
| | Age of Business reports provide a |
| | comprehensive view of best and worst |
| | segments of the customer's portfolio of |
| | accounts. |
| Manage risk by corporate | Corporate Linkage Exposure report |
| family exposure | provides a list of the largest customers and |
| | legal ownership connections between |
| | entities |
| Adjust credit policies | Score Trend report provides |
| based on credit risk | account/portfolio level insight into changes |
| distribution, customer | in credit risk levels which may prompt a |
| segmentation and | change in credit policies. |
| changes in credit risk | Industry report provides a risk-based, |
| | comprehensive view of customer |
| | segmentation by multiple level SIC code |
| | (industry). |
| | Geography, Size of Business and Age of |
| | Business reports provides a risk-based, |
| | comprehensive view of customer |
| | segmentation in the portfolio of accounts. |
| | Portfolio Distribution report provides |
| | customer distribution based on risk bands, |
| | useful information when setting credit |
| | policies. |
| Calculate or Validate Bad | Risk by Bad Debt Reserve provides a |
| Debt Reserve calculations | validation of an existing bad debt |
| | calculation and a best practice bad debt |
| | reserve approach |
| Benchmark credit risk | Benchmark report provides a comparison |
| profile with a national | of risk levels for a customer and the |
| average | national average |
| Manage customer | Credit Limit Utilization report provides a |
| Credit Limits | risk based view into credit limit utilization |
| | highlighting risks, opportunities and |
| | potential changes to credit policies |
| Prioritize customers | Aging report prioritizes collections by |
| for collection activities | oldest/biggest dollars with risk based |
| | approach |
| Communicate credit | Risk Executive Dashboard provides an easy |
| policy performance within | way to create a custom credit report to |
| an organization | communicate within the organization |

Table 2 shows a correlation between customer use cases and PRM 2 reports.

TABLE 2

| | Portfolio Risk Manager |
|---|---|
| Customer Use Cases | Report |
| Management Reports: | Risk Executive |
| PRM 2 lets you create management reports | Dashboard |
| in several ways. There is a Risk Executive | |
| Dashboard that lets you choose a series of | |
| tables, charts and custom commentary to | |
| compile your own report. Each Table, | |
| Chart & Drill-down List also allows for | |
| printing, saving to a PDF or e-mailing as | |
| another way of sharing the insights the | |
| reports offer. Save time and money by | |
| leveraging easy to understand 1-click | |
| reports. | |
| Modify Credit & Collection Policies based | Portfolio Distribution |
| on current risk levels: | Failure & Delinquency |
| Several reports enable you to see the | Score Trends |
| distribution of Delinquency and Failure | National Benchmark |
| Risk to help identify if you have the right | Segmentation by Industry, |
| mix of risk in your portfolio. Too little risk | Geography, Years in |
| and you may be leaving money on the | Business, Size of |
| table; too much risk and you may need to | Business |
| tighten your acceptance criteria. | |
| Benchmark your Performance: | National Benchmark |
| Understand how you compare to Failure & | Segmentation by Industry, |
| Delinquency National Benchmarks. Use | Geography, Years in |
| this as input to determining if adjustments | Business, Size of |
| are needed in your policies as stated above. | Business |
| Also see how segments of your portfolio | |
| compare to other segments. You may find | |
| that certain types of customers need a | |
| different treatment from a decisioning, | |
| account review, collections and service | |
| perspective. Maximize profitability by | |
| ensuring the policies in place growth | |
| revenue while reducing costs. | |
| Prioritize Collections: | Outstanding Dollar |
| Take a risk based approach to prioritizing | Ranges |
| collections. In addition to looking at who | Failure & Delinquency |
| owes the most and how old the receivable | Aging Categories |
| is, you should also take into consideration | |
| their ability to pay. The riskier the account | |
| the sooner collections efforts need to start. | |
| Also, there may be large dollars | |
| outstanding that have very low risk and can | |
| help improve cash flow since they have the | |
| propensity to pay. Reduce DSO by | |
| leveraging these techniques. | |
| Calculate your Bad Debt Reserve: | Bad Debt Reserve |
| Leverage a model for a consistent | |
| repeatable way of taking a risk based | |
| approach to calculating your bad debt | |
| reserve. Auditors want to see a repeatable | |
| viable method, use this tool to create or | |
| validate your bad debt reserve. Over | |
| reserving takes profits off the bottom line | |
| so be confident in the amount you reserve. | |
| Partner with sales & marketing by | Failure & Delinquency |
| providing high quality prospects: The flip | Credit Limit Utilization |
| side to taking a risk based approach is to | Total Outstanding Dollar |
| identify customers that have additional | Ranges |
| capacity. Identify customers where | Score Trends |
| additional product can be sold, and | |
| segments of customers that make up the | |
| profile of what your best customers look | |
| like so marketing can find prospects that | |
| match that profile. | |
| Define Corporate Family Exposure: | Corporate Family Linkage |
| As your customer base grows, | |
| understanding who is legally related to who | |
| can be very difficult. Keeping up with all | |
| the merger & acquisition activity also can | |
| be hard. Corporate Family Linkage helps | |
| you understand customers that are related | |
| so you can understand the total exposure | |
| to a corporate family. Just because one | |
| account has strong scores, does not mean | |
| their parent or other subsidiaries do. | |
| Understand the total risk of the family | |
| members you do business with to see if you | |
| are over exposed. | |
| Manage Credit Limits and Exposure: | Credit Limit Utilization |
| By understanding the risk of customers | |
| that are over utilizing or under utilizing | |
| their credit limits you will have insight into | |
| which accounts need to be adjusted to | |
| bring them more in line with your policies. | |
| Customers that are over utilizing their | |
| credit limits and have a high risk need | |
| immediate attention and credit line review, | |
| while customers that are underutilizing | |
| their credit limits and have low risk are | |
| good prospects for sales and marketing to | |
| approach. | |

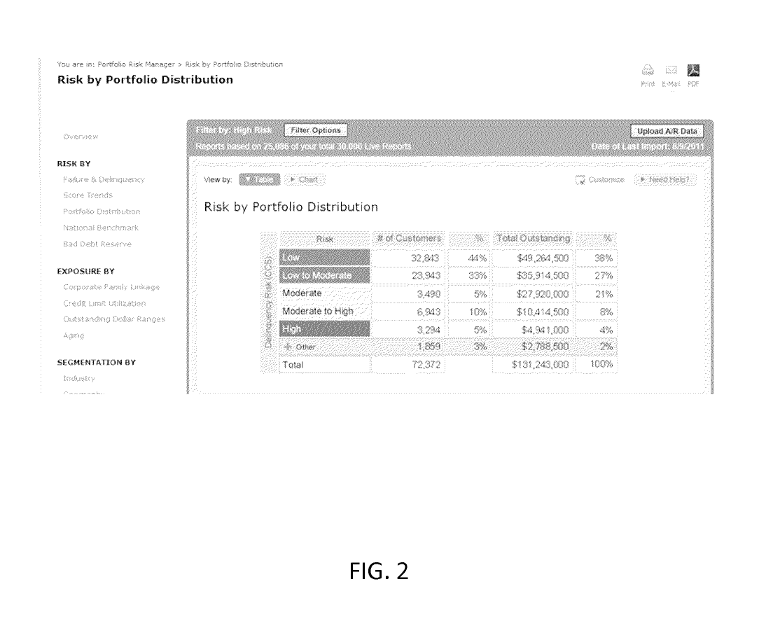

FIG. 2 is a screen shot of a sample table provided by PRM 2.

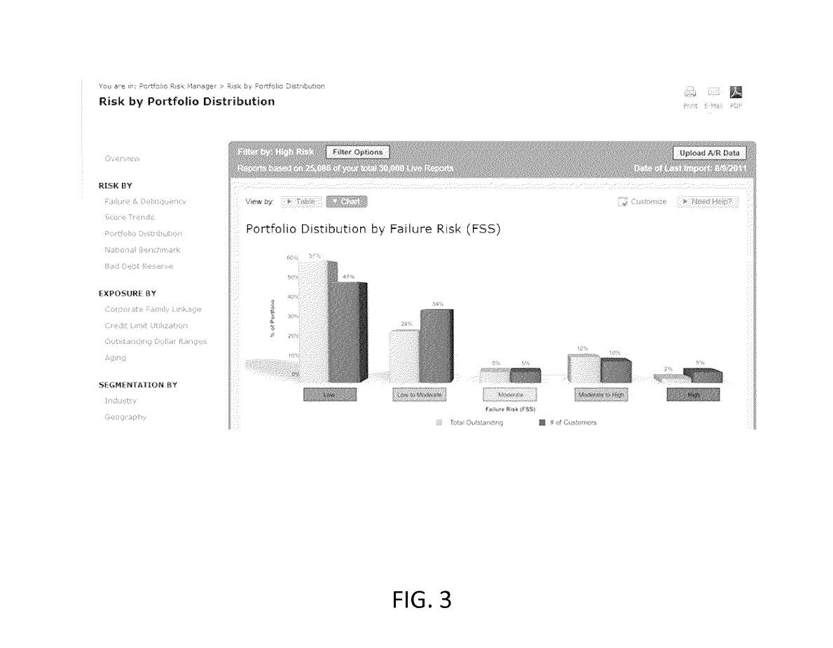

FIG. 3 is a screen shot of a sample bar chart provided by PRM 2.

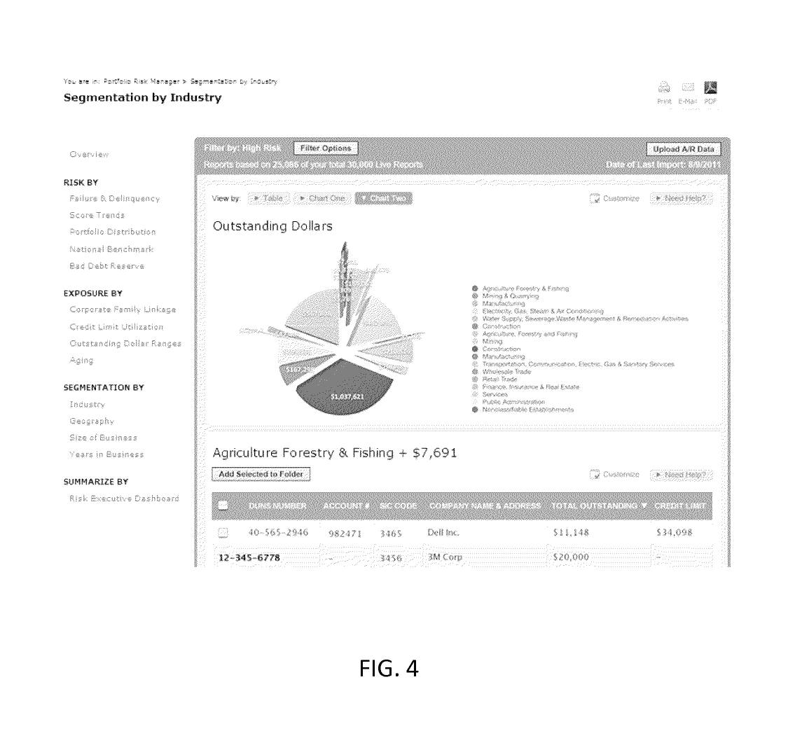

FIG. 4 is a screen shot of a sample pie chart provided by PRM 2.

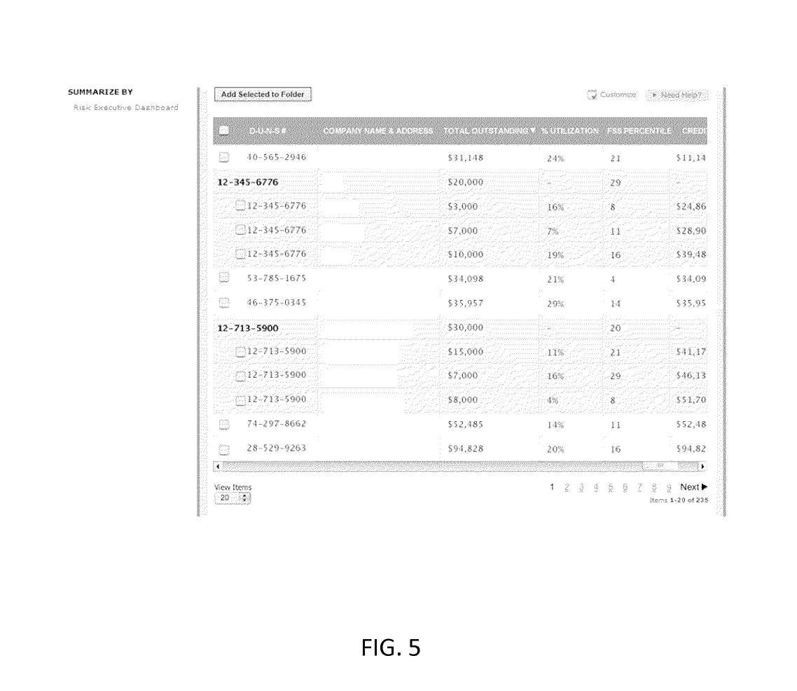

FIG. 5 is a screen shot of a sample drill-down provided by PRM 2.

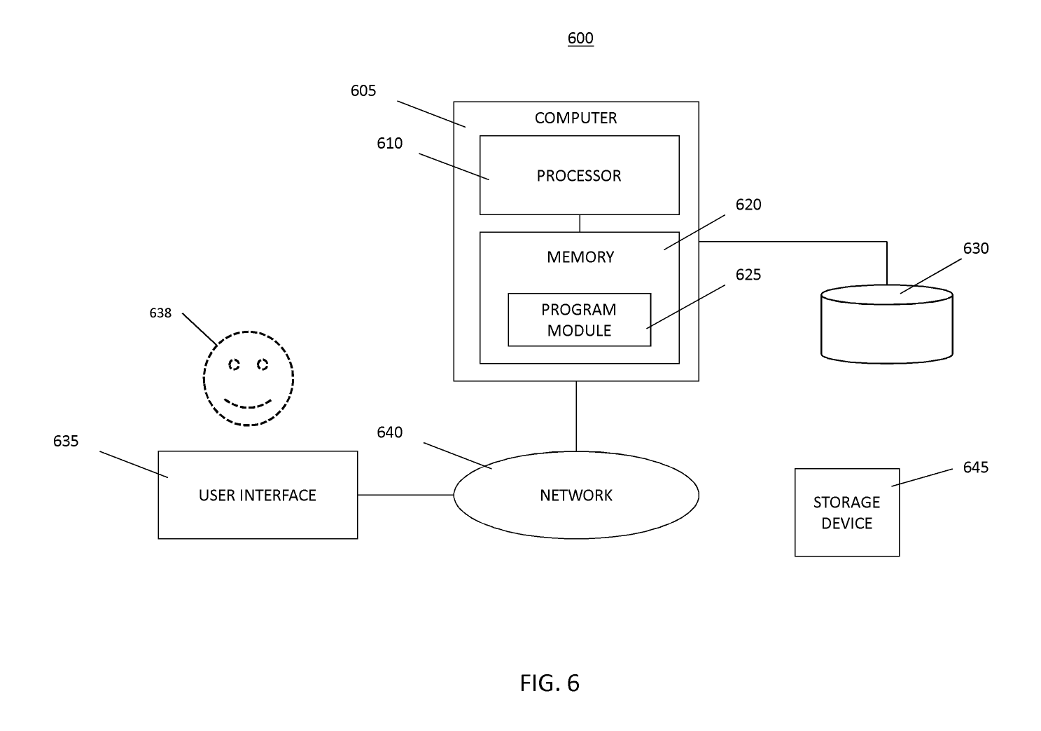

FIG. 6 is a block diagram of a system 600, for implementation of application platform 1, and more particularly PRM 2. System 600 includes a computer 605 coupled to a network 640, e.g., the Internet.

Computer 605 includes a processor 610, and a memory 620. Although computer 605 is represented herein as a standalone device, it is not limited to such, but instead can be coupled to other devices (not shown) in a distributed processing system.

Processor 610 is an electronic device configured of logic circuitry that responds to and executes instructions.

Memory 620 is storage device, i.e., a tangible computer-readable storage medium, encoded with a computer program. In this regard, memory 620 stores data and instructions that are readable and executable by processor 610 for controlling the operation of processor 610. Memory 620 may be implemented in a random access memory (RAM), a hard drive, a read only memory (ROM), or a combination thereof. One of the components of memory 620 is a program module 625.

Program module 625 contains instructions for controlling processor 610 to execute the operations of application platform 1 and PRM 2 described herein. The term “module” is used herein to denote a functional operation that may be embodied either as a stand-alone component or as an integrated configuration of a plurality of sub-ordinate components. Thus, program module 625 may be implemented as a single module or as a plurality of modules that operate in cooperation with one another. Moreover, although program module 625 is described herein as being installed in memory 620, and therefore being implemented in software, it could be implemented in any of hardware (e.g., electronic circuitry), firmware, software, or a combination thereof.

System 600 also includes a database 630 for storage of data. Database 630 may be embodied as a single storage device or as a plurality of storage devices in a distributed storage system. In this regard, database 630 provides storage for database 1.4. Reporting database 2.4 may be embodied as a component of program module 625 or as a component of database 630.

In the present document, although we describe operations being performed by application platform 1 and PRM 2 or its subordinate processes, the operations are actually being performed by processor 610.

A user interface 635 is coupled to computer 605 via network 640. User interface 635 includes an input device, such as a keyboard or speech recognition subsystem, for enabling a user 638 to communicate information and command selections to computer 605. User interface 635 also includes an output device such as a display. A cursor control such as a mouse, track-ball, or joy stick, allows user 638 to manipulate a cursor on the display for communicating additional information and command selections to computer 605. In practice, system 600 will include a plurality of user interfaces such as user interface 635 that interact with computer 605 via network 640.

Processor 610 outputs, to user interface 635, a result of an execution of the operations described herein, for example, reports generated by PRM 2. Processor 610 could also direct the output to a remote device (not shown) via network 640.

While program module 625 is indicated as already loaded into memory 620, it may be configured on a storage device 645 for subsequent loading into memory 620. Storage device 645 is a tangible computer-readable storage medium and can be any conventional storage medium that stores program module 625 thereon form. Examples of storage device 645 include a compact disk, a magnetic tape, a read only memory, an optical storage media, a hard drive or a memory unit consisting of multiple parallel hard drives, and a universal serial bus (USB) flash drive. Alternatively, storage device 645 can be a random access memory, or other type of electronic storage, located on a remote storage system and coupled to computer 605 via network 640.

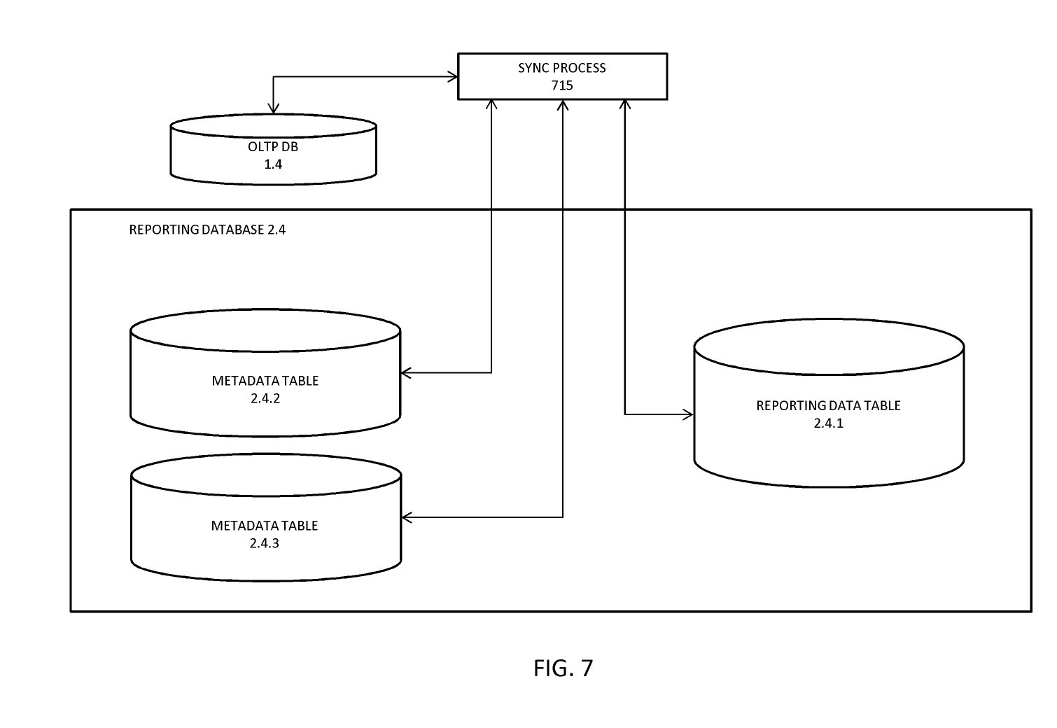

FIG. 7 is a functional block diagram showing a sync process 715 that interacts with database 1.4 and Reporting database 2.4, and synchronizes database 1.4 and Reporting Data table 2.4.1. Sync process 715 accesses data from various tables that store information about live reports, accounts, etc., and populates Reporting Data table 2.4.1. Sync process 715 thus synchronizes Portfolio Risk Management data. Sync process 715 runs every time new records are imported into database 1.4, or any operation related to PRM specific fields in database 1.4 is performed.

Sync process 715 is embodied within PRM 2 and includes a synchronization process that synchronizes Reporting database 2.4, and more particularly Reporting Data table 2.4.1, with database 1.4. Reporting database 2.4 includes two metadata tables, namely a metadata table 2.4.2 and a metadata table 2.4.3, that facilitate the synchronization process.

Reporting Data table 2.4.1 contains data that will be utilized to prepare a PRM report. In an exemplary embodiment, Reporting Data table 2.4.1 is a denormalized hash-partitioned transaction table with 190 columns holds the data required for all the PRM reports. Denormalization is a process of attempting to optimize read performance of a database by adding redundant data or by grouping data. One of the advantages of hash partitioning is fast retrieval of data.

Metadata table 2.4.2 holds process-specific queries to update Reporting Data table 2.4.1. That is, when sync process 715 wishes to update Reporting Data table 2.4.1, sync process 715 will obtain, from Reporting Data table 2.4.1, a query to perform the update. Metadata table 2.4.2 enables the addition and/or removal of any of the process without impact on other components. The significance of metadata table 2.4.2 is described in further detail, below.

Metadata table 2.4.3 holds customization and column information about Reporting Data table 2.4.1. It is effectively a cross-reference between fields in database 1.4 and corresponding data storage column locations in Reporting Data table 2.4.1. Metadata table 2.4.3 gets column information about custom fields contained in database 1.4 and columns to be updated in Reporting Data table 2.4.1. The significance of metadata table 2.4.3 is described in further detail, below.

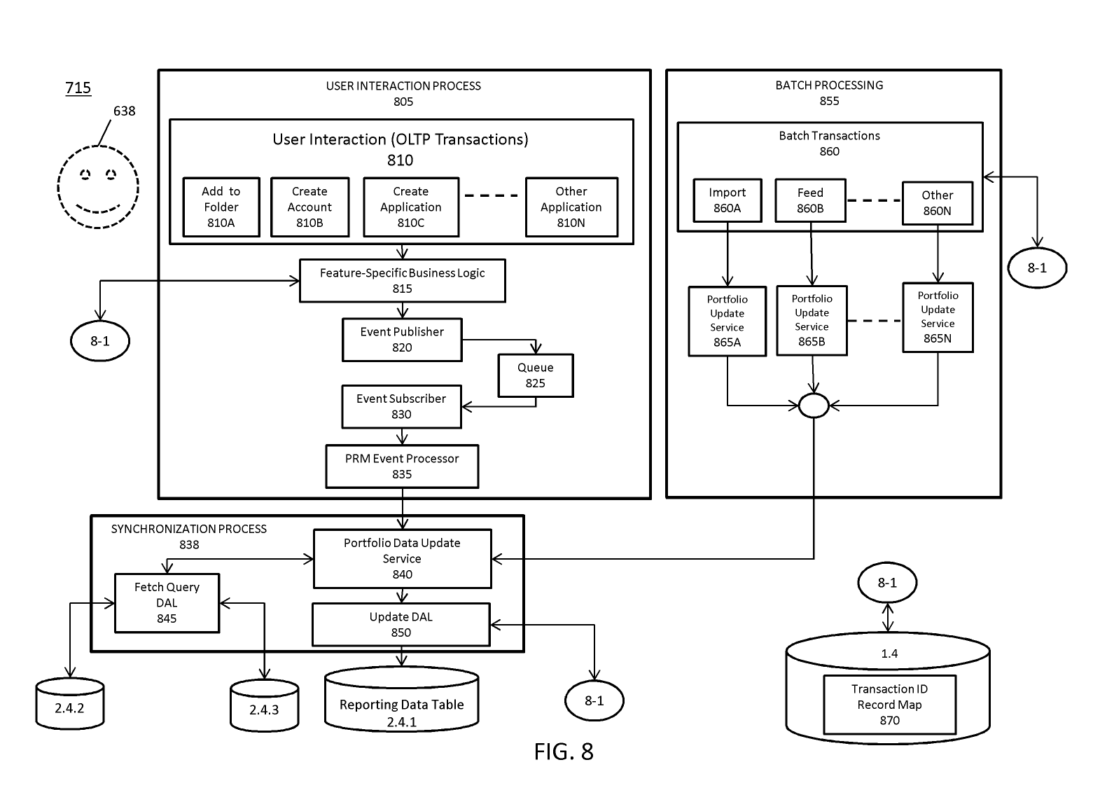

FIG. 8 is a functional block diagram of sync process 715. Sync process 715 includes a user interaction process 805, batch processing 855 and a synchronization process 838. User interaction process 805 processes online user transactions that update database 1.4, and batch processing 855 performs batch processes that update database 1.4. User interaction process 805 is responsible for all PRM-specific online transactions. Sync process 715 updates Reporting Data table 2.4.1 to include data from the updates to database 1.4.

Below, we will first consider the updating of Reporting Data table 2.4.1 in response to an execution of an online user transaction in user interaction process 805, and then consider the updating of Reporting Data table 2.4.1 in response to an execution of a batch process in batch processing 855.

User interaction process 805 includes user interaction (OLTP transactions) 810, feature-specific business logic 815, an event publisher 820, a queue 825, an event subscriber 830, and a PRM event processor 835.

Event publisher 820, queue 825, event subscriber 830, and PRM event processor 835 are components of Reporting Business Logic tier 2.2.

User interaction 810 handles online transaction processing performed by users, e.g., user 638, on a website. User interaction 810 involves processing by one or more of a plurality of user interactive processes that update database 1.4. User interaction 810 may include any desired number of such processes, but several are illustrated and designated herein as processes 810A, 810B, 810C and 810N. Process 810A is a process to add data to a folder, process 810A is a process to create an account, process 810C is a process to create an application, and process 810N generically represents a process for any other application.

Each of processes 810A, 810B, 810C and 810N is identifiable by a process identifier (ID). When such a process is invoked, the user interaction 810 passes a corresponding process ID to feature-specific business logic 815.

For example, assume that user 802 would like to add data to a folder in database 1.4. Accordingly, through user interface 635, user 638 interacts with process 810A, and process 810A passes, to feature-specific business logic 815, a request accompanied by the process ID for process 810A.

Feature-specific business logic 815 processes functions related to specific operations, i.e., processes 810A-810N. Feature-specific business logic 815 receives the request with the process ID from user interaction 810 and updates database 1.4, and more specifically, a record in database 1.4, in accordance with the corresponding process, e.g., process 810A. In FIG. 8, feature-specific business logic 815 is shown as being connected to database 1.4 by way of a connecting bubble 8-1. Feature-specific business logic 815 passes to event publisher 820 (a) the process ID, and (b) a record ID that identifies the updated record.

Event publisher 820 is a mechanism for sending events, asynchronously, to queue 825. Event publisher 820 receives the process ID and the record ID from feature-specific business logic 815, and generates an event that will ultimately be used to notify synchronization process 838 that a particular process 810A-810N has been performed on a particular record in database 1.4. The event is a data element that includes the process ID and the record ID. Event publisher 820 inserts the event on the back end of queue 825.

Queue 825 is a first-in-first out (FIFO) queue that holds a plurality of events that were posted to it from event publisher 820. By employing queue 825, sync process 715 de-couples back-end processing, i.e., processing downstream of queue 825, from front-end processing, i.e., processing upstream of queue 825. As a result, sync process 715 is more fault-tolerant of a case where the back-end processing is temporarily unavailable or overloaded. Additionally, the presence of queue 825 allows sync process 715 to synchronize Reporting Data table 2.4.1 to database 1.4 even in a case where database 1.4 is being concurrently updated by multiple users. Accordingly, queue 825 may be of any desired length, i.e., hold any desired number of events.

Event subscriber 830 reads events from the front end of queue 825, and creates an object that includes the process ID and the record ID. An object is a self-contained module of data and its associated processing. The object is a collection of information that is used to pass information from one layer to another. Event subscriber 830 passes the object to PRM event processor 835.

PRM event processor 835 processes events that event subscriber 830 read from queue 825. PRM event processor 835 is a delegator that gets the information from event subscriber 830 and passes it to synchronization process 838. Accordingly, PRM event processor 835 receives the object from event subscriber 830, and passes the object to synchronization process 838.

Synchronization process 838 is responsible for interactions with Reporting Data table 2.4.1. Synchronization process 838 includes a portfolio data update service 840, a fetch query Data Access Layer (DAL) 845, and an update DAL 850. A DAL provides simplified access to data stored in persistent storage of some kind, in this case Reporting database 2.4 or database 1.4. Synchronization process 838, as explained below, copies data from database 1.4 to Reporting Data table 2.4.1.

Portfolio data update service 840, fetch query DAL 845, and update DAL 850 are components of Reporting Data Access tier 2.3.

Portfolio data update service 840 receives the object from PRM event processor 835 and extracts the process ID and the record ID. As explained below, portfolio data update service 840 will interact with each of fetch query DAL 845 and update DAL 850 to effectuate the synchronization of Reporting Data table 2.4.1 with database 1.4.

Portfolio data update service 840 passes the process ID to fetch query DAL 845.

Fetch query DAL 845 is responsible for fetching, from metadata tables 2.4.2 and 2.4.3, information that will be used by update DAL 850 to update Reporting Data table 2.4.1. Fetch query DAL 845 receives the process ID from portfolio data update service 840 and uses it to access each of metadata table 2.4.2 and metadata table 2.4.3. From metadata table 2.4.2, based on the process ID, fetch query DAL 845 obtains a process-specific query that will be used to update Reporting Data table 2.4.1. For example, if the process ID identifies process 810A, metadata table 2.4.2 will provide a query that will be used to update Reporting Data table 2.4.1 in a manner that corresponds to the addition of data to a folder in database 1.4. From metadata table 2.4.3, based on the process ID, fetch query DAL 845 will obtain a cross-reference between fields in database 1.4 and corresponding data storage column locations in Reporting Data table 2.4.1. Fetch query DAL 845 adds data from metadata table 2.4.3 to the query from metadata table 2.4.2, thus yielding an update query, and returns the update query to portfolio data update service 840.

Portfolio data update service 840 receives the update query from fetch query DAL 845, and passes the update query and the record ID to update DAL 850.

Update DAL 850 is responsible for updating Reporting Data table 2.4.1. Update DAL 850 receives the update query and the record ID from portfolio data update service 840. Update DAL 850 utilizes the record ID to read data from database 1.4, and utilizes the update query to update Record Data table 2.4.1. In FIG. 8, update DAL 850 is shown as being connected to database 1.4 by way of connecting bubble 8-1. To the extent that a user interaction, e.g., process 810A, updated database 1.4, Reporting Data table 2.4.1 now includes the same data.

We will now consider the updating of Reporting Data table 2.4.1 in response to an execution of a batch process in batch processing 855.

Batch processing 855 is responsible for all PRM-specific batch transactions. Batch processing 855 includes batch transactions 860, and a plurality of portfolio update services, three of which are illustrated and designated herein as 865A, 865B and 865N.

Batch transactions 860 are offline transactions that are usually performed in chunk, asynchronously to other activities performed by sync process 715. Batch transactions 860 include a plurality of batch processes, each of which updates a batch of records in database 1.4. Batch transactions 860 may include any desired number of such processes, but several are illustrated and designated herein as processes 860A, 860B and 860N. Process 860A is a process for importing user-provided data, process 860A is a process for a daily feed of data, and process 860N generically represents any other batch process. In FIG. 8, batch transactions 860 is shown as being connected to database 1.4 by way of connecting bubble 8-1.

When process 860A is executed, it (a) creates and stores into database 1.4, a transaction ID record map 870 that contains identifiers of records in database 1.4 that process 860A updated, and (b) assigns a batch transaction ID that identifies transaction ID record map 870. Thus, the batch transaction ID identifies a data structure that contains identifiers of records in the updated batch of records in database 1.4. Similarly, each of processes 860B-860N, when executed, (a) creates and stores a transaction ID record map, and (b) assigns a batch transaction ID that identifies the transaction ID record map. Additionally, each of batch transactions 860 is identifiable by a process ID.

For purpose of example, we will consider an execution of process 860A.

Portfolio update service 865A acquires the process ID and the batch transaction ID from process 860A, and sends the process ID and the batch transaction ID, in the form of an object, to synchronization process 838, and more specifically, portfolio data update service 840. Portfolio update services 865B-865N function similarly to portfolio update service 865A, with respect to processes 860B-860N.

Portfolio data update service 840 receives the process ID and the batch transaction ID from portfolio update service 865A. Similarly to operations described above for the processing of a user interaction 810, portfolio data update service 840 will interact with each of fetch query DAL 845 and update DAL 850 to effectuate the synchronization of Reporting Data table 2.4.1 with database 1.4.

Portfolio data update service 840 passes the process ID to fetch query DAL 845.

Fetch query DAL 845 receives the process ID from portfolio data update service 840 and uses it to access each of metadata table 2.4.2 and metadata table 2.4.3. From metadata table 2.4.2, based on the process ID, fetch query DAL 845 obtains a process-specific query that will be used to update Reporting Data table 2.4.1. For example, if the process ID identifies process 860A, metadata table 2.4.2 will provide a query that will be used to update Reporting Data table 2.4.1 in a manner that corresponds to the batch importing of user-provided data into database 1.4. From metadata table 2.4.3, based on the process ID, fetch query DAL 845 will obtain a cross-reference between fields in database 1.4 and corresponding data storage column locations in Reporting Data table 2.4.1. Fetch query DAL 845 adds data from metadata table 2.4.3 to the query from metadata table 2.4.2, thus yielding an update query, and returns the update query to portfolio data update service 840.

Portfolio data update service 840 receives the update query from fetch query DAL 845, and passes the update query and the batch transaction ID to update DAL 850.

Update DAL 850 receives the update query and the batch transaction ID from portfolio data update service 840. Update DAL 850 utilizes the batch transaction ID to access transaction ID record map 870, and thus obtains the record IDs of records that were updated by process 860A. Now having the record IDs, update DAL 850 reads data from database 1.4, and utilizes the update query to update Record Data table 2.4.1. To the extent that process 860A updated database 1.4, Reporting Data table 2.4.1 now includes the same data.

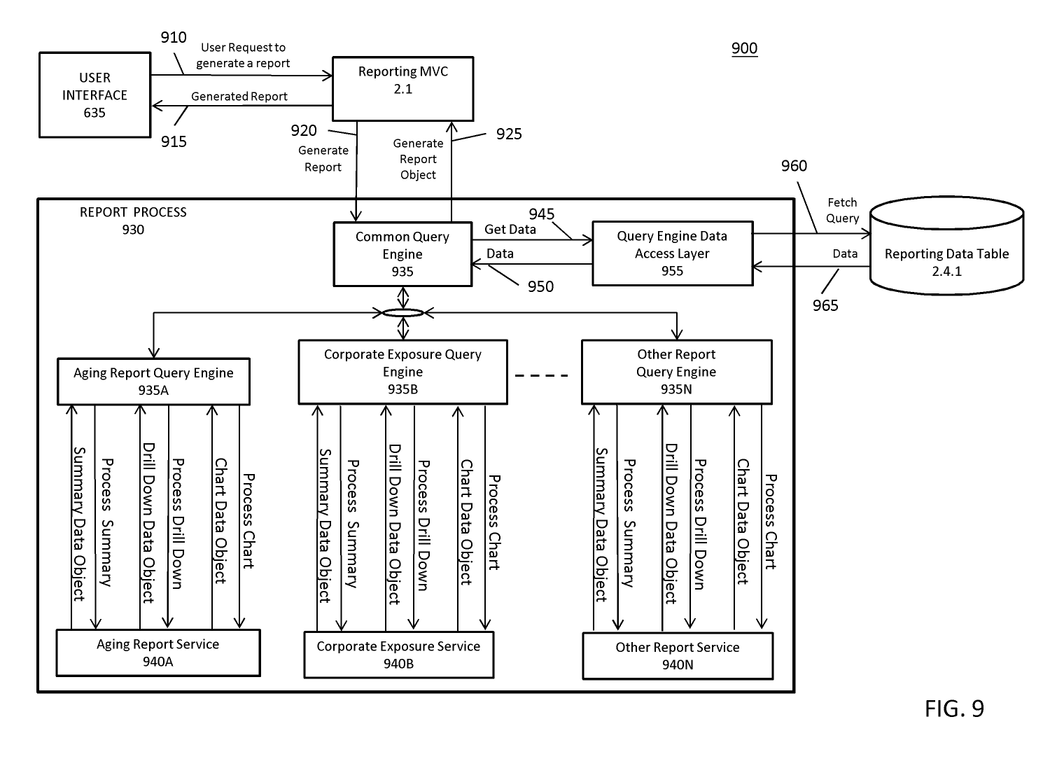

FIG. 9 is a functional block diagram of a process 900 for generating a report from data in Reporting Data table 2.4.1. Process 900 employs Reporting MVC tier 2.1, and a report process 930.

Report process 930 includes (a) a common query engine 935, (b) a plurality of query engines 935A and 935B-935N, (c) a plurality of services 940A and 940B-940N that correspond to query engines 935A and 935B-935N, respectively, and (d) a query engine data access layer 955.

Common query engine 935, query engines 935A-935N, and services 940A-940N are components of Reporting Business Logic tier 2.2. Query engine data access layer 955 is a component of Reporting Data Access tier 2.3.

Each of query engines 935A and 935B-935N in association with its corresponding service 940A and 940B-940N is for the preparation of a particular report. In this regard, services 940A-940N perform report-specific operation. Query engine 935A and service 940A are for preparation of an aging report. Query engine 935B and service 940B are for preparation of a corporate exposure report. Query engine 935N and service 940N generically represent processes for preparation of any other report. Report process 930 may include any desired number of such query engines and services.

Each query engine 935A-935N and its corresponding service 940A-940N participates in the preparation of a chart, a drill down, and a summary table. The summary table displays customer data, if an import has been performed, and risk data as a numerical matrix. The chart is a graphical representation of the summary table, and is comprised of customer data, if an import has been performed, and risk data. The drill down is a detailed view of a section chosen by a user in the summary table or chart of a portfolio risk manager report.

The preparation of a report is initiated by Reporting MVC tier 2.1 receiving a request 910 from user interface 635. Accordingly, Reporting MVC tier 2.1 sends a request 920 to common query engine 935.

Common query engine 935 is a template that is used by report-specific query engines, i.e., query engines 952A-935N. Common query engine 935 presses account receivable data based on various user-defined operations. Common query engine 935 receives request 920 from Reporting MVC tier 2.1, and depending on the type of report being requested, invokes an appropriate one of query engines 935A-935N. For purpose of example, we will consider the preparation of an aging report, i.e., by employment of query engine 935A and service 940A. Accordingly, common query engine 935 makes a call to query engine 935A.

Query engine 935A makes three calls to service 940A, namely, process chart, process drill down, and process summary. In response, service 940A returns a chart data object, a drill down data object, and a summary table data object, respectively.

Each of the process chart call, the process drill down call, and the process summary call contains credit risk data that will be used to prepare a report. The chart data object contains a graphical representation of data shown in the summary table of the portfolio risk manager reports. The drill down data object contains data shown in the drill down list in a detailed view of a section chosen by the user in the summary table or chart of the portfolio risk manager report. The summary table data object contains a representation of data to be shown in the summary table of the portfolio risk manager reports.

Query engine 935A returns the chart data object, the drill down data object, and the summary data object to common query engine 935.

Common query engine 935 receives the chart data object, the drill down data object, and the summary data object from query engine 935A, and sends to query engine data access layer 955, a request 945 that includes information that query engine data access layer 955 needs to obtain data from Reporting Data table 2.4.1 for a particular report. Request 945 fetches data from Query Engine DAL 955 with report specific parameters.

Query engine data access layer 955 is responsible for fetching data from Reporting Data table 2.4.1. Query engine data access layer 955, based on the information in request 945, formulates and sends to Reporting Data table 2.4.1, a fetch query 960.

Reporting Data table 2.4.1 receives fetch query 960, and in response returns data 965.

Query engine data access layer 955 receives data 965, and sends the data, in the form of data 950, to common query engine 935.

Common query engine 935 receives data 950, and sends it to Reporting MVC tier 2.1 in the form of a report object 925.

Reporting MVC tier 2.1 receives report object 925, and based thereon, prepares and transmits to user interface 635, a report 915.

A technical benefit of the utilization of Reporting Data table 2.4.1, rather than database 1.4, for the preparation of reports, relieves database 1.4 of processing burdens associated with the preparation of the reports. Additionally, because of the synchronization of database 1.4 and Reporting Data table 2.4.1, as was performed by sync process 715, the data in Reporting Data table 2.4.1 is very current, and the reports prepared therefrom will also contain very current data.

Although database 1.4 and Reporting database 2.4 are used for portfolio risk management, the techniques described herein can be employed with databases containing any type of content. That is, sync process 715 can be used to synchronize two databases, regardless of the nature of the content in the databases.

Generally, the techniques described herein provide for a method that includes:
updating a record in a first database in accordance with an update process; and
issuing to a synchronization process, (a) a process identifier that identifies the update process, and (b) a record identifier that identifies the record,
wherein the synchronization process:
   obtains, based on the process identifier, (a) a query to update a second database, and (b) a cross-reference between the record and a location in the second database;
   reads data from the record; and
   utilizes the query to write the data to the location in the second database.

The method may further include, prior to the issuing:
inserting into a back end of a queue, an event that includes the process identifier and the record identifier;
reading the event from a front end of the queue; and
extracting the process identifier and the record identifier from the event for issuance to the synchronization process,
and may further include:
creating an object for issuance to the synchronization process, wherein the object includes the process identifier and the record identifier,
wherein the issuing comprises sending the process identifier and the record identifier by way of the object.

The method may also include:
receiving a request to prepare a report;
reading the data from the second database;
preparing the report, wherein the preparing includes incorporating the data into the report; and
sending the report to a user interface.

Additionally, wherein the data concerns a business entity, the preparing may comprise:
obtaining a data universal numbering system (DUNS) number for the business entity;
constructing a corporate family hierarchical tree that includes the business entity and other business entities, based on the DUNS number;
obtaining additional data concerning the other business entities from the second database; and
incorporating the additional data into the report.

Furthermore, the report may include information selected from the group consisting of:
(a) payment performance for at least one of the business entity and the other business entities;
(b) a list of the largest customers and legal ownership connections between the business entity and the other business entities;
(c) changes in credit risk levels for at least one of the business entity and the other business entities;
(d) a view of customer segmentation by multiple level standard industrial classification (SIC) code;
(e) geography, size and age of at least one of the business entity and the other business entities;
(f) portfolio distribution of at least one of the business entity and the other business entities based on risk bands;
(g) a validation of an existing bad debt calculation or estimation of bad debt collection for at least one of the business entity and the other business entities;
(h) a comparison of credit risk levels for at least one of the business entity and the other business entities and a national average;
(i) a credit limit for at least one of the business entity and the other business entities; and
(j) collections prioritized by oldest/biggest dollars, for at least one of the business entity and the other business entities.

There is also provided a method that includes:
receiving (a) a process identifier that identifies a process that updated a record in a first database, and (b) a record identifier that identifies the record;
obtaining, based on the process identifier, (a) a query to update a second database, and (b) a cross-reference between the record and a location in the second database;
reading data from the record; and
utilizing the query to write the data to the location in the second database.

There is also provided a method that includes:
updating a batch of records in a first database in accordance with a batch update process; and
issuing to a synchronization process, (a) a process identifier that identifies the batch update process, and (b) a batch transaction identifier that identifies a data structure that contains identifiers of records in the batch of records,
wherein the synchronization process:
   obtains, based on the process identifier, (a) a query to update a second database, and (b) a cross-reference between the records and locations in the second database;
   obtains, from the data structure, the identifiers of the records;
   reads data from the records; and
   utilizes the query to write the data to the locations in the second database.

There is also provided a method that includes:
receiving (a) a process identifier that identifies a batch update process that updated a batch of records in a first database, and (b) a batch transaction identifier that identifies a data structure that contains identifiers of records in the batch of records;
obtaining, based on the process identifier, (a) a query to update a second database, and (b) a cross-reference between the records and locations in the second database;
obtaining, from the data structure, the identifiers of the records;
reading data from the records; and
utilizing the query to write the data to the locations in the second database.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances.

What is claimed is:

1. A method for portfolio risk management, comprising:
updating a transaction database with data relating to an operation of an entity;
synchronizing a reporting database to said transaction database, wherein said synchronizing comprises copying said data from said transaction database to said reporting database;
receiving a request to prepare a report;
obtaining said data from said reporting database;
preparing said report from said data obtained from said reporting database; and
outputting said report to a user interface.

2. The method of claim 1,
wherein said updating comprises:
updating a record in said transaction database in accordance with an update process; and
issuing to a synchronization process, (a) a process identifier that identifies said update process, and (b) a record identifier that identifies said record, and
wherein said synchronizing is performed by said synchronization process.

3. The method of claim 2, wherein said synchronizing comprises:
obtaining, based on said process identifier, (a) a query to update said reporting database, and (b) a cross-reference between said record and a location in said reporting database;
reading data from said record; and
utilizing said query to write said data to said location in said reporting database.

4. The method of claim 1,
wherein said updating comprises:
updating a batch of records in said transaction database in accordance with a batch update process; and
issuing to a synchronization process, (a) a process identifier that identifies said batch update process, and (b) a batch transaction identifier that identifies a data structure that contains identifiers of records in said batch of records, and
wherein said synchronizing is performed by said synchronization process.

5. The method of claim 4, wherein said synchronizing comprises:
obtaining, based on said process identifier, (a) a query to update said reporting database, and (b) a cross-reference between said records and locations in said reporting database;
obtaining, from said data structure, said identifiers of said records;
reading data from said records; and
utilizing said query to write said data to said locations in said reporting database.

6. The method of claim 1,
wherein said data concerns a business entity, and
wherein said preparing comprises:
obtaining a data universal numbering system (DUNS) number for said business entity;
constructing a corporate family hierarchical tree that includes said business entity and other business entities, based on said DUNS number;
obtaining additional data concerning said other business entities from said reporting database; and
incorporating said additional data into said report.

7. The method of claim 6, wherein said report includes information selected from the group consisting of:
(a) payment performance for at least one of said business entity and said other business entities;
(b) a list of the largest customers and legal ownership connections between said business entity and said other business entities;
(c) changes in credit risk levels for at least one of said business entity and said other business entities;
(d) a view of customer segmentation by multiple level standard industrial classification (SIC) code;
(e) geography, size and age of at least one of said business entity and said other business entities;
(f) portfolio distribution of at least one of said business entity and said other business entities based on risk bands;
(g) a validation of an existing bad debt calculation or estimation of bad debt collection for at least one of said business entity and said other business entities;
(h) a comparison of credit risk levels for at least one of said business entity and said other business entities and a national average;
(i) a credit limit for at least one of said business entity and said other business entities; and
(j) collections prioritized by oldest/biggest dollars, for at least one of said business entity and said other business entities.

8. A system for portfolio risk management, comprising:
a transaction database; a reporting database;
a processor; and
a memory that contains instructions that are readable by said processor to control said processor to:
update said transaction database with data relating to an operation of an entity;
synchronize said reporting database to said transaction database, wherein said synchronizing comprises copying said data from said transaction database to said reporting database;
receive a request to prepare a report;
obtain said data from said reporting database;
prepare said report from said data obtained from said reporting database; and
output said report to a user interface.

9. The system of claim 8,
wherein to update said transaction database, said instructions control said processor to:
update a record in said transaction database in accordance with an update process; and
issue to a synchronization process, (a) a process identifier that identifies said update process, and (b) a record identifier that identifies said record, and
wherein to synchronize said reporting database, said instructions control said processor to execute said synchronization process.

10. The system of claim 9, wherein to perform said synchronization process, said instructions control said processor to:
obtain, based on said process identifier, (a) a query to update said reporting database, and (b) a cross-reference between said record and a location in said reporting database;
read data from said record; and
utilize said query to write said data to said location in said reporting database.

11. The system of claim 8,
wherein to update said transaction database, said instructions control said processor to:
update a batch of records in said transaction database in accordance with a batch update process; and
issue to a synchronization process, (a) a process identifier that identifies said batch update process, and (b) a batch transaction identifier that identifies a data structure that contains identifiers of records in said batch of records, and
wherein to synchronize said reporting database, said instructions control said processor to execute said synchronization process.

12. The system of claim 11, wherein to execute said synchronization process, said instructions control said processor to:
obtain, based on said process identifier, (a) a query to update said reporting database, and (b) a cross-reference between said records and locations in said reporting database;
obtain, from said data structure, said identifiers of said records;
read data from said records; and
utilize said query to write said data to said locations in said reporting database.

13. The system of claim 8,
wherein said data concerns a business entity, and
wherein to prepare said report, said instructions control said processor to:
obtain a data universal numbering system (DUNS) number for said business entity;
construct a corporate family hierarchical tree that includes said business entity and other business entities, based on said DUNS number;
obtain additional data concerning said other business entities from said reporting database; and
incorporate said additional data into said report.

14. The system of claim 13, wherein said report includes information selected from the group consisting of:
(a) payment performance for at least one of said business entity and said other business entities;
(b) a list of the largest customers and legal ownership connections between said business entity and said other business entities;
(c) changes in credit risk levels for at least one of said business entity and said other business entities;
(d) a view of customer segmentation by multiple level standard industrial classification (SIC) code;
(e) geography, size and age of at least one of said business entity and said other business entities;
(f) portfolio distribution of at least one of said business entity and said other business entities based on risk bands;
(g) a validation of an existing bad debt calculation or estimation of bad debt collection for at least one of said business entity and said other business entities;
(h) a comparison of credit risk levels for at least one of said business entity and said other business entities and a national average;
(i) a credit limit for at least one of said business entity and said other business entities; and
(j) collections prioritized by oldest/biggest dollars, for at least one of said business entity and said other business entities.

15. A storage device that comprises instructions that are readable by a processor, and that control said processor to:
update a transaction database with data relating to an operation of an entity;
synchronize a reporting database to said transaction database, wherein said synchronizing comprises copying said data from said transaction database to said reporting database;
receive a request to prepare a report;
obtain said data from said reporting database;
prepare said report from said data obtained from said reporting database; and
output said report to a user interface.

16. The storage device of claim 15,
wherein to update said transaction database, said instructions control said processor to:
update a record in said transaction database in accordance with an update process; and
issue to a synchronization process, (a) a process identifier that identifies said update process, and (b) a record identifier that identifies said record, and
wherein to synchronize said reporting database, said instructions control said processor to execute said synchronization process.

17. The storage device of claim 16, wherein to perform said synchronization process, said instructions control said processor to:
obtain, based on said process identifier, (a) a query to update said reporting database, and (b) a cross-reference between said record and a location in said reporting database;
read data from said record; and
utilize said query to write said data to said location in said reporting database.

18. The storage device of claim 15,
wherein to update said transaction database, said instructions control said processor to:
update a batch of records in said transaction database in accordance with a batch update process; and
issue to a synchronization process, (a) a process identifier that identifies said batch update process, and (b) a batch transaction identifier that identifies a data structure that contains identifiers of records in said batch of records, and
wherein to synchronize said reporting database, said instructions control said processor to execute said synchronization process.

19. The storage device of claim 18, wherein to execute said synchronization process, said instructions control said processor to:
obtain, based on said process identifier, (a) a query to update said reporting database, and (b) a cross-reference between said records and locations in said reporting database;
obtain, from said data structure, said identifiers of said records;
read data from said records; and
utilize said query to write said data to said locations in said reporting database.

20. The storage device of claim 15,
wherein said data concerns a business entity, and
wherein to prepare said report, said instructions control said processor to:
obtain a data universal numbering system (DUNS) number for said business entity;
construct a corporate family hierarchical tree that includes said business entity and other business entities, based on said DUNS number;
obtain additional data concerning said other business entities from said reporting database; and
incorporate said additional data into said report.

21. The storage device of claim 20, wherein said report includes information selected from the group consisting of:
(a) payment performance for at least one of said business entity and said other business entities;
(b) a list of the largest customers and legal ownership connections between said business entity and said other business entities;
(c) changes in credit risk levels for at least one of said business entity and said other business entities;
(d) a view of customer segmentation by multiple level standard industrial classification (SIC) code;
(e) geography, size and age of at least one of said business entity and said other business entities;
(f) portfolio distribution of at least one of said business entity and said other business entities based on risk bands;
(g) a validation of an existing bad debt calculation or estimation of bad debt collection for at least one of said business entity and said other business entities;
(h) a comparison of credit risk levels for at least one of said business entity and said other business entities and a national average;
(i) a credit limit for at least one of said business entity and said other business entities; and
(j) collections prioritized by oldest/biggest dollars, for at least one of said business entity and said other business entities.
